(19) United States
(12) Patent Application Publication
(10) Pub. No.: US 2023/0324298 A1
(43) Pub. Date: Oct. 12, 2023

(54) SPECTROSCOPY APPARATUS

(71) Applicant: STICHTING VU, Amsterdam (NL)

(72) Inventors: Alfred Holzwarth, Mülheim a.d. Ruhr (DE); Jacopo URBANI, Amsterdam (NL); Lukas JASMONTAS, Druskininkai (LT)

(21) Appl. No.: 18/023,172

(22) PCT Filed: Aug. 19, 2021
(86) PCT No.: PCT/EP2021/073066

§ 371 Date: Feb. 24, 2023

(30) Foreign Application Priority Data
Aug. 24, 2020 (GB) 2013208.0

(51) Int. Cl. G01N 21/64

(52) U.S. Cl. CPC G01N 21/6408; G01N 2021/635

(57) ABSTRACT

There is provided a spectroscopy apparatus for measuring fluorescence signals from a photosynthetic object. The spectroscopy apparatus comprises:
one or more light excitation sources (26,28) operable to carry out time-varying excitation of the fluorescence from the photosynthetic object; and
one or more fluorescence-sensitive detection channels (36,38,44,46) configured to simultaneously record the fluorescence as a function of time with a microsecond to millisecond time resolution and as a function of wavelength with a wavelength resolution of 10 nm or better, responsive to the excitation of the fluorescence from the photosynthetic object by the or each light excitation source (26,28).

The invention relates to a spectroscopy apparatus, a method of measuring chlorophyll and/or other pigment fluorescence from a photosynthetic object (e.g. intact cells of photosynthetic algae or bacteria, an intact plant leaf, one or more parts of or the whole of a plant, one or more parts of or the whole of a canopy) using a spectroscopy apparatus, a computer-implemented method of identifying a condition of a photosynthetic object, and a computer program.

It is known to measure fluorescence signals from a photosynthetic object to study the effects of varying environmental conditions on photosynthetic organisms and to gain insight into their physiological status, their health status, their abiotic/biotic stress status, as well as for performing studies related to phenotyping as well as genotyping of photosynthetic objects.

According to a first aspect of the invention, there is provided a spectroscopy apparatus for measuring fluorescence signals from a photosynthetic object, the spectroscopy apparatus comprising:
one or more light excitation sources operable to carry out time-varying excitation of the fluorescence from the photosynthetic object; and
one or more fluorescence-sensitive detection channels configured to simultaneously record the fluorescence as a function of time with a microsecond to millisecond time resolution and as a function of wavelength with a wavelength resolution of 10 nm or better, responsive to the excitation of the fluorescence from the photosynthetic object by the or each light excitation source.

The fluorescence signal(s) may include chlorophyll fluorescence emitted by the photosynthetic object and/or fluorescence emitted from another pigment of the photosynthetic object. The photosynthetic object may include, but is not limited to, part of or whole of a photosynthetic organism, part of or the whole of a plant, part of or the whole of an alga, part of or the whole of a photosynthetic bacterium, a suspension of photosynthetic cells, an intact leaf, part of or the whole of a canopy, or a photosynthetic cell assembly such as corals and photosynthetic mats, etc.

The photosynthetic object may be contained or fixed within the spectroscopy apparatus. Alternatively the photosynthetic object may be kept apart from the spectroscopy apparatus so that the fluorescence signal(s) may be remotely measured by the spectroscopy apparatus. The invention may be used to measure fluorescence signals emitted by a plurality of photosynthetic objects at the same time.

Optionally the one or more light excitation sources may be operable to carry out time-varying excitation of the fluorescence from the photosynthetic object at multiple excitation wavelengths.

Optionally the one or more fluorescence-sensitive detection channels may include one or more fluorescence-sensitive detection units or devices. In a preferred embodiment of the invention, the wavelength resolution of the recorded fluorescence information is achieved continuously across the entire fluorescence spectrum or is achieved using three or more distinct narrow wavelength bands, or a combination thereof.

The inventors have found that the ability of the invention to simultaneously obtain the time-resolved and wavelength-resolved fluorescence signal(s) at high resolution enables a combination of the time and spectral information of the fluorescence in a way that improves the amount and quality of information extracted from the fluorescence signal(s). In particular, the configuration of the invention enables reliable detection of spectrally and kinetically resolved fluorescence changes for rapidly characterising a wide range of conditions for various photosynthetic objects and also enables separation and identification of fluorescence contributions and effects of different underlying physiological processes that give rise to the fluorescence changes. This is particularly important because photosynthetic objects illuminated by light emit fluorescence that contains various fluorescence components that show pronounced differences in their temporal and spectral characteristics depending on the physiological state of the photosynthetic object, its health status, its abiotic/biotic stress status and so on. Separation of these fluorescence components in spectrum and time also allows combination with advanced data analysis methods for implementing various sensitive plant phenotyping and genotyping methods.

The invention not only can be used in a laboratory setting but also can be readily configured as a field-ready spectroscopy apparatus that is sufficiently compact and lightweight to be portable and/or hand-held and/or airborne, e.g. flown by a drone or another flying machine, in order to perform measurements from a distance (e.g. a distance in a range of a few centimetres to 10 metres between the spectroscopy apparatus and the photosynthetic object).

Presently available conventional fluorescence measurement techniques applied to photosynthetic objects that do not use simultaneous high time and wavelength resolutions are incapable of providing the same amount and quality of information as the invention.

The configuration of the invention enables measurement of different components of the fluorescence signal(s) (preferentially includes chlorophyll fluorescence but may alternatively or additionally include one or more other types of fluorescence signals) from the photosynthetic object, non-limiting examples of which are set out as follows.

In a first example, the recorded fluorescence information may include fluorescence induction (FI) information. This may include fast fluorescence induction information.

In a second example, the recorded fluorescence information may include non-photochemical quenching (NPQ) information.

The recorded fluorescence information may include FI information and/or NPQ information. Additionally or alternatively the recorded fluorescence information may relate to or cover information on another type of fluorescence characterization or measuring mode.

The configuration of the invention enables spectrally and kinetically resolved separation and identification of the components and/or processes that contribute to the FI and NPQ, thus providing more meaningful and reliable information about the photosynthetic object and its internal processes and mechanisms.

Non-limiting examples and components of the light excitation source include a light emitting diode, a laser (e.g. a pulse laser, a modulated laser), a lamp, and a combination of two or more thereof, allowing one or more wavelengths of excitation light.

Non-limiting examples and components of the or each fluorescence-sensitive detection channel include the use of one or more optical lenses, one or more optical fibres, one or more optical reflectors, a spectrograph, a spectrograph employing a charge-coupled device (CCD) or photodiode array as a detection unit, a multi-element array detector, one or more photodiodes and one or more optical filters, as well as a combination of two or more of the preceding examples and components.

The time-varying excitation of the fluorescence from the photosynthetic object may be carried out in different ways in order to facilitate the simultaneous time-resolved and wavelength-resolved measurements of the fluorescence at high resolution.

In embodiments of the invention, the time-varying excitation may be in the form of a repeating pulsed excitation. This may involve carrying out the time-varying excitation to provide time intervals between consecutive pulsed excitations of the fluorescence from the photosynthetic object. Individual pulsed excitations of the repeating pulsed excitation may be repeated with any size interval for any number of times. The repeating pulsed excitation preferably has an excitation frequency of 0.1 kHz or higher, more preferably an excitation frequency of 1 kHz to 100 kHz. The repeating pulsed excitation may be a repeating single pulsed excitation or a repeating burst pulsed excitation. The single pulsed excitation may have a microsecond to millisecond pulse duration. The total duration for the repeating single pulsed excitation may be in the range of 1 microsecond to hundreds of microseconds (e.g. at least 1 microsecond and less than 1 millisecond). The total duration for the repeating burst pulsed excitation may be in the range of tens of microseconds to many minutes with bursts that consist of programmable individual excitation pulses lasting from 1 microsecond to less than 1 millisecond and programmable intervals lasting from 0.1 millisecond up to minutes. The repeating burst pulsed excitation may include tens to hundreds of pulses per burst (e.g. at least 10 pulses per burst and below 1000 pulses per burst).

In the invention, the time-varying excitation may include single turnover pulses or bursts of single turnover pulses. The turnover pulses can be used to reliably close photosynthetic reaction centers.

In further embodiments of the invention, the time-varying excitation may be in the form of a periodically modulated excitation. The periodically modulated excitation may be based on a periodic waveform of any shape (sinusoidal, non-sinusoidal, or any other shape with or without a fixed or variable background). Preferably the periodically modulated excitation has an excitation frequency in the range of 1 mHz to 100 kHz. More preferably the periodically modulated excitation has an excitation frequency in the range of 1 mHz to tens of kHz (e.g. at least 1 mHz and less than 100 kHz).

In the invention, the time-varying excitation may include a combination of repeating pulsed excitation and repeating frequency-modulated excitation.

The time and wavelength resolutions of the simultaneous time-resolved and wavelength-resolved measurements of the fluorescence, as well the choice of pulsed excitation, the excitation wavelength, and the choice of pulsed excitation sequence, may vary depending on the characteristics of the photosynthetic object, the intended application and the desired information. The spectroscopy apparatus may be configured to include a controller that is programmed to rapidly switch between different pulsed excitation sequences, so as to provide measurement flexibility.

Preferably the time resolution is in the range of 0.5 microseconds to 10 milliseconds. More preferably the time resolution is in the range of 0.5 microseconds to several tens of microseconds (e.g. at least 10 microseconds and less than 100 microseconds). Even more preferably the time resolution is in the range of 0.5 microseconds to 10 microseconds.

Preferably the wavelength resolution is in the range of 1 nm to 10 nm. More preferably the wavelength resolution is in the range of 1 nm to 5 nm.

Preferably each function of the spectroscopy apparatus of the invention, e.g. the application of the pulsed excitation or the pulsed excitation sequence(s) and the recording of the fluorescence signal(s), is fully controlled by a freely programmable automatic operation under computer control. The results of each measurement cycle may be stored, together with all process parameters, automatically on a computer storage medium for later (automatic or manual) analysis.

The recording of the fluorescence signal(s) in simultaneously time-resolved and wavelength-resolved modes at high resolution may be followed by automatic/user-defined/user-controlled analysis of the recorded fluorescence information, preferably by hardware running specialised computer programs that enable the analysis and characterisation of the fluorescence information using a variety of advanced data analysis methods, non-limiting examples of which are described throughout the specification. Depending on the application, this analysis may be used to separate the various fluorescence contributions and components in their spectral and kinetic properties in order to gain insight into the mechanisms of photosynthetic reactions sequences, the physiological status of the photosynthetic object, the health and stress conditions of the photosynthetic object and/or for applying machine learning and artificial intelligence methods to the recorded fluorescence information in order to characterise, in an automated fashion, the photosynthetic object, for example, in terms of its health and stress conditions or according to phenotyping or genotyping criteria.

In still further embodiments of the invention, the electronic circuit may include a processor and memory including computer program code, the memory and computer program code configured to, with the processor, enable the electronic circuit at least to analyse the recorded fluorescence information from the photosynthetic object so as to identify or characterise a condition of the photosynthetic object. In such embodiments, the memory and computer program code may be configured to, with the processor, enable the electronic circuit at least to analyse modified derivative functions of the recorded fluorescence information from the photosynthetic object so as to identify or characterise a condition of the photosynthetic object. For example, the memory and computer program code may be configured to, with the processor, enable the electronic circuit at least to analyse modified derivative functions of the recorded fluorescence information from the photosynthetic object on a logarithmic time scale so as to identify or characterise a condition of the photosynthetic object.

Configuration of the electronic circuit in this manner provides automatic analysis of the recorded fluorescence information and automatic identification or characterisation of the condition of the photosynthetic object, which beneficially provides users with useful information about the photosynthetic object without requiring the intervention of specialised personnel to carry out the analysis. This is particularly useful for deploying the apparatus for use in field applications.

The analysis may be carried out directly on the recorded fluorescence information or be carried out on modified functions of the recorded fluorescence information, e.g. modified derivative functions on the logarithmic time scale, or other mathematically defined derived functions.

Optionally the memory and computer program code may be configured to, with the processor, enable the electronic circuit at least to analyse the recorded fluorescence information from the photosynthetic object to identify or characterise the condition of the photosynthetic object by providing the recorded fluorescence information as input to a machine learning algorithm or model and identify or characterise the condition of the photosynthetic object based on an output of the machine learning algorithm or model. In such embodiments, the machine learning algorithm or model may be or may include, but is not limited to, a long short-term memory (LSTM) algorithm or a neural network.

Configuration of the electronic circuit in this manner provides the spectroscopy apparatus with machine-learned selectivity to facilitate the automatic analysis of the recorded fluorescence information and automatic identification or characterisation of the condition(s) of the photosynthetic object(s). The machine learning algorithm or model may be used to create a self-learning system that informs users about the condition of the photosynthetic object and provide recommended actions to remedy the condition of the photosynthetic object. The self-learning system may be designed to provide the recommended actions through use of a predefined look-up table or through training by ever increasing data sets incorporated into an expert system or database to automatically refine and improve its prediction and advice capabilities. This is particularly useful for deploying the apparatus for use in field applications, especially for testing early stress conditions or plant phenotyping and in particular with operators that are not specialists in the application and analysis of such information.

The step of identifying or characterising the condition of the photosynthetic object based on an output of the machine learning algorithm or model may include analysis of stress phenomena associated with a stress condition of the photosynthetic object.

The step of identifying or characterising the condition of the photosynthetic object based on an output of the machine learning algorithm or model may include plant phenotyping or genotyping.

The computer-implemented method may be carried out to identify or characterise the condition of the photosynthetic object(s) in an agriculture area or greenhouse so as to monitor the photosynthetic object(s) in the agriculture area or greenhouse for optimal growth conditions of the photosynthetic object(s) or deviations thereof.

The computer-implemented method may be carried out to identify or characterise the condition of the photosynthetic object(s) in an ecosystem so as to monitor the ecosystem and inform about physiological health or stress conditions of the ecosystem.

The machine learning algorithm or model may be applied, but is not limited, to the recorded fluorescence information or applied to mathematically defined derived functions of the recorded fluorescence information, e.g. modified derivative functions on the logarithmic time scale.

The condition of the photosynthetic object may include, but is not limited to, at least one of: a physiological condition of the photosynthetic object; a health condition of the photosynthetic object; and a stress condition (e.g. an abiotic or biotic stress condition) of the photosynthetic object. Non-limiting examples of physiological, health and stress conditions of the photosynthetic object are described throughout the specification.

Monitoring health and stress levels of crop and energy plants is of fundamental importance for the optimisation of growth and quality conditions in various areas, such as agriculture, energy crops and algae growth for biofuels, forestry in terms of optimal water and nutrient supply and detection of general environmental stress situations, e.g. effects of global warming on ecosystems such as forests, coral reefs and so on. In particular chlorophyll fluorescence is a very sensitive early reporter of various kinds of abiotic stresses (e.g. heat stress, water stress, pollution stress, nutrition stress) and biotic stresses (e.g. weeds, pathogens) on photosynthetic objects that may adversely affect their optimal growth conditions (such as fertiliser use and irrigation access) and physiological status.

The ability of the invention to obtain the simultaneous time-resolved and wavelength-resolved measurements of the fluorescence at high resolution enables extraction of large amounts of high quality information about the physiological, health and stress conditions of the photosynthetic object from the fluorescence signal(s).

The stress condition of the photosynthetic object may include, but is not limited to, at least one of: a type of the stress condition (e.g. dry stress, temperature stress, light stress, nutrient stress etc.) of the photosynthetic object; and a level of the stress condition of the photosynthetic object. Non-limiting examples of types and levels of stress conditions of the photosynthetic object are described throughout the specification.

The ability of the invention to accurately identify and characterise the type and degree of different stress factors of the photosynthetic object permits creation of optimal growth and quality conditions for the photosynthetic object. This is made possible by the ability of the invention to obtain the simultaneous time-resolved and wavelength-resolved measurements of the fluorescence at high resolution and optimised measuring conditions (e.g. in terms of applied pulse sequences etc.) in order to extract large amounts of high quality information from the fluorescence signal(s).

According to a second aspect of the invention, there is provided a method of measuring fluorescence signals from a photosynthetic object using a spectroscopy apparatus according to any one of the first aspect of the invention and its embodiments, the method comprising the steps of:
by the or each light excitation source, carrying out time-varying excitation of the fluorescence from the photosynthetic object; and
by the or each fluorescence-sensitive detection channel, simultaneously recording the fluorescence as a function of time with a microsecond to millisecond time resolution and as a function of wavelength with a wavelength resolution of 10 nm or better, responsive to the excitation of the fluorescence from the photosynthetic object by the or each light excitation source.

The features and advantages of the first aspect of the invention and its embodiments apply mutatis mutandis to the features and advantages of the second aspect of the invention and its embodiments.

In the method of the invention, the wavelength resolution of the recorded fluorescence information may be achieved continuously across the entire recorded fluorescence spectrum.

In the method of the invention, the wavelength resolution of the recorded fluorescence information may be achieved using three or more distinct narrow wavelength bands.

In the method of the invention, the wavelength resolution of the recorded fluorescence information may be achieved continuously across the entire recorded fluorescence spectrum or alternatively in combination with using three or more distinct narrow wavelength bands.

According to a third aspect of the invention, there is provided a computer-implemented method of identifying or characterising a condition of a photosynthetic object, the method comprising the steps of:
recording fluorescence information from the photosynthetic object by carrying out the method according to any one of the second aspect of the invention and its embodiments; and
analysing the recorded fluorescence information from the photosynthetic object so as to identify or characterise a condition of the photosynthetic object.

According to a fourth aspect of the invention, there is provided a computer-implemented method of identifying or characterising a condition of a photosynthetic object, the method comprising the steps of:
collecting a set of data by carrying out the method according to any one of the second aspect of the invention and its embodiments, wherein the collected set of data includes the recorded fluorescence information from the photosynthetic object;
creating a training set including the collected set of data;
training a machine learning algorithm or model using the training set; and
identifying or characterising the condition of the photosynthetic object based on an output of the machine learning algorithm or model.

The features and advantages of the first and second aspects of the invention and their embodiments apply mutatis mutandis to the features and advantages of the third and fourth aspects of the invention and their embodiments.

In embodiments of the fourth aspect of the invention, the machine learning algorithm or model may be or may include a long short-term memory (LSTM) algorithm, a neural network and/or some other machine learning or AI-based algorithm or method.

The analysis of the recorded fluorescence information may include global kinetic and spectral analysis that combines analysis of many spectral and kinetic data sets resulting from the fluorescence measurements and/or global kinetic and spectral target analysis applying specific models of the internal processes, regulation mechanisms, light responses and other environmental responses of the photosynthetic objects.

In embodiments of the computer-implemented method of the invention, the condition of the photosynthetic object may include at least one of: a physiological condition of the photosynthetic object; a health condition of the photosynthetic object; and a stress condition of the photosynthetic object. In such embodiments, the stress condition of the photosynthetic object may include at least one of: a type of the stress condition of the photosynthetic object; and a level of the stress condition of the photosynthetic object.

According to a fifth aspect of the invention, there is provided a computer program comprising computer code configured to perform the method of any one of the third aspect of the invention, the fourth aspect of the invention and their embodiments.

The features and advantages of the first, second, third and fourth aspects of the invention and their embodiments apply mutatis mutandis to the features and advantages of the fifth aspect of the invention and its embodiments.

In embodiments of the invention, the electronic circuit may be, may include, may communicate with or may form part of one or more of an electronic device, a portable electronic device, a portable telecommunications device, a microprocessor, a mobile phone, a personal digital assistant, a tablet, a phablet, a desktop computer, a laptop computer, a server, a cloud computing network, a smartphone, a smartwatch, smart eyewear, and a module for one or more of the same.

Exemplary applications of the invention include or relate to, but are not limited to:
agriculture, such as crop growth control and surveillance;
optimal greenhouse cultures;
precision agriculture;
energy production, such as biofuel production by plants or algae;
environmental monitoring and protection on ecosystems, such as forests, coral reefs, oceans, mangrove forests and the like;
food production;
forest management;
plant breeding;
plant phenotyping;
plant genotyping;
fundamental plant physiology and photosynthesis research.

The invention may be used in exemplary locations and sites that may include or relate to, but are not limited to:
forests, jungles, woods and the like;
fields;
gardens and greenhouses;
marine ecosystems, such as coral reefs;
waterbodies, such as ponds, lakes, rivers, seas.

In modern agriculture and food production, the aim is to increase productivity, improve quality and safety and minimise environmentally adverse effects. This requires optimisation of all accessible growth parameters and avoidance of adverse stress phenomena on food and energy producing plants and algae. Any deviation from optimal growth conditions, such as undersupply or oversupply of nutrients, variations in irrigation access and adverse temperature effects, may lead to stress on the photosynthetic machinery of these photosynthetic organisms that in turn results in reductions in food and energy output and quality.

On the environmental side, climate change and global warming induce severe stress in the photosynthetic machinery of photosynthetic organisms in critical ecosystems, such as boreal forests, tropical forests, sub-tropical rain forests, mangroves, and coral reefs. It is therefore highly desirable to monitor and analyse the condition of the photosynthetic organisms in these critical ecosystems, preferably at an early stage—i.e. before visible or other damage or deterioration occurs, in order to be able to carry out appropriate remedial action before it is too late to do so.

When the photosynthetic object is kept apart from the spectroscopy apparatus, the spectroscopy apparatus is configured to have a temporary position (e.g. the temporary position is held for a few hundred milliseconds) or a permanent position relative to the photosynthetic object. The spectroscopy apparatus may be held at a distance in a range of a few centimetres to 10 metres between the spectroscopy apparatus and the photosynthetic object. This is particularly useful in field applications and plant phenotyping and plant breeding. Alternatively similar measurement conditions may be achieved by flying the spectroscopy apparatus using a drone or another flying machine above the photosynthetic object(s), above an agricultural field containing the photosynthetic object(s) or above an ecosystem (e.g. a forest, a coral reef or another ecosystem) containing the photosynthetic object(s).

It will be appreciated that the use of the terms “first” and “second”, and the like, in this patent specification is merely intended to help distinguish between similar features, and is not intended to indicate the relative importance of one feature over another feature, unless otherwise specified.

Within the scope of this application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

Preferred embodiments of the invention will now be described, by way of non-limiting examples, with reference to the accompanying drawings in which:

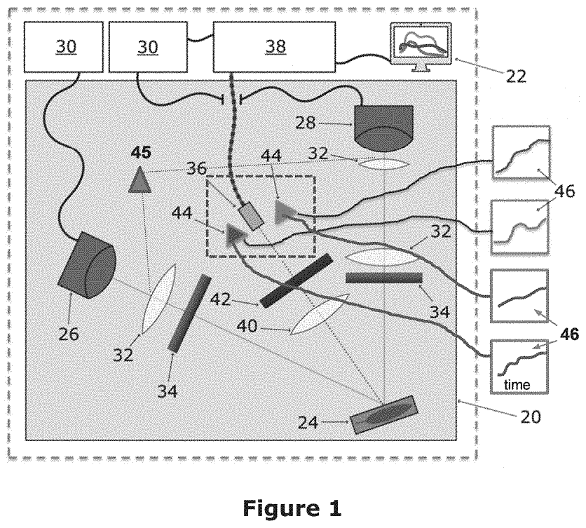

FIG. 1 shows a spectroscopy apparatus according to an embodiment of the invention;

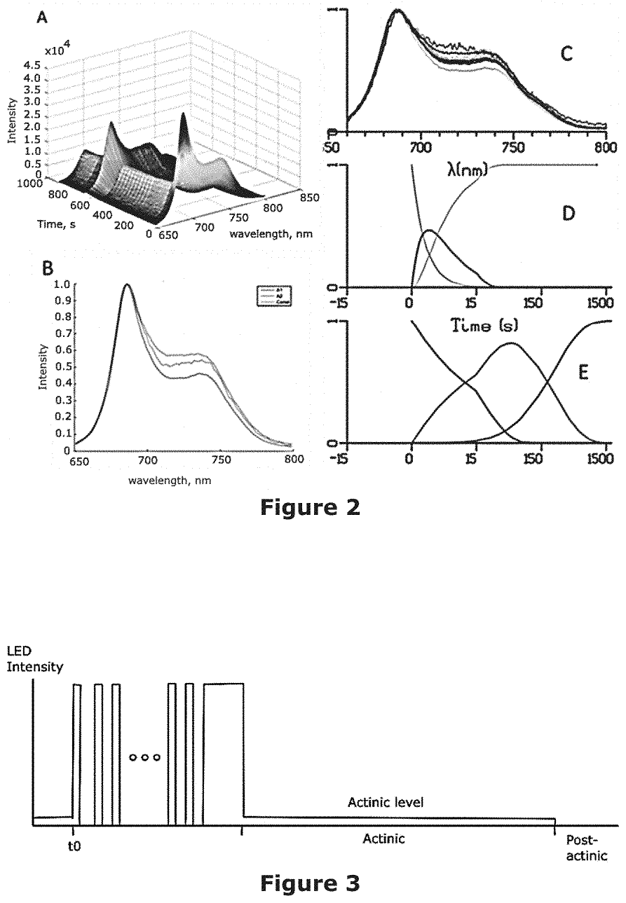

FIG. 2 illustrates a repeating burst pulse excitation mode employed for simultaneous time-resolved and wavelength-resolved measurement of fluorescence signals from photosynthetic objects; and

FIGS. 3 to 10 show data obtained from simultaneous time-resolved and wavelength-resolved measurements of fluorescence from plants.

The figures are not necessarily to scale, and certain features and certain views of the figures may be shown exaggerated in scale or in schematic form in the interests of clarity and conciseness.

The following embodiments of the invention are described with reference to the configuration of the invention as a plant health and stress monitoring system, particularly for early biotic and abiotic stress detection and analysis and for optimising plant growth conditions. It will be appreciated that the following embodiments of the invention apply mutatis mutandis to other applications relating to photosynthetic objects and other types of fluorescence emitted by photosynthetic objects, non-limiting examples of which are described throughout the specification.

Chlorophyll fluorescence is a sensitive indicator of many different kinds of plant stresses, since the photosynthetic machinery responds to all kinds of environmental parameters and their changes (such as light, water, nutrition, temperature and others) in all green plants in a sensitive manner. Chlorophyll fluorescence measurements permit extraction of information about the status of the plant, and are affected by water stress, nitrogen, temperature, chlorophyll and flavonoid contents, pH level, photosynthetic status and other physiological parameters, independently from soil interference, leaf area or biomass status. Chlorophyll fluorescence tends to change long before damage resulting from stress becomes visible or detectable. Hence, chlorophyll fluorescence can be used as early warnings of stress to detect adverse conditions of plants.

The inventors have found that chlorophyll fluorescence, when measured as a combination of simultaneously recorded time-resolved and wavelength-resolved information, and measured in the modes described above and below according to the invention, is particularly suitable for providing early warnings of stress and/or to detect any other adverse conditions of plants and other photosynthetic tissue.

A spectroscopy apparatus according to an embodiment of the invention is shown in FIG. 1. The spectroscopy apparatus comprises an enclosure 20, an electronic circuit 22, a sample holder 24, a light excitation source and a fluorescence-sensitive detection channel. The enclosure 20 is configured to block external light from entering its interior in order to create a dark enclosure 20, preferably a light-tight enclosure.

In use, the sample holder 24 is housed inside the dark enclosure 20 (preferably a light-tight enclosure) and holds a photosynthetic object. In the embodiment shown, the photosynthetic object is a plant leaf. Other photosynthetic objects may be used in other embodiments.

The light excitation source includes at least a pair of light emitting diodes (LED) 26,28 that are powered by respective power supplies 30. More than two LEDs may be used. A first of the LEDs is a red LED 26 with a centre wavelength of 620 or 650 nm, while a second of the LEDs is a blue LED 28 with a centre wavelength of 420 or 475 nm. Each of the LEDs 26,28 can provide any one of: a low intensity actinic background illumination or a high intensity (≥50,000 microEinsteins per second per square metre) single pulse or burst pulse, or a repetitively modulated excitation, or a combination thereof. Thus each of the LEDs 26,28 be used as an actinic source, a high power excitation source, or a combination thereof. Single colour LEDs with other centre wavelengths are possible. Both LEDs 26,28 are fully programmable to provide a continuous background light excitation or a repeating pulsed light excitation, which may be in the form of a single pulse excitation or a burst pulse excitation. This is achieved by controlling each power supply 30 to supply a continuous power (for actinic background illumination) or pulsed power to the corresponding LED 26,28.

The repeating pulsed excitation preferably has a microsecond pulse duration (preferably 10 microsecond to a millisecond) and an excitation frequency of 0.1 kHz to 100 kHz (depending what is achievable for the particular pulse duration, allowing for suitable intervals of 0.1 to 10 milliseconds lengths). It will be appreciated that the choice of wavelength or colour of each of the LEDs 26,28 may vary depending on the required properties of the light excitation for a particular photosynthetic object.

It is envisaged that, in other embodiments of the invention, a periodically modulated light excitation may be used in place of the repeating pulsed light excitation (single pulse or burst pulse). The periodically modulated light excitation is preferably based on a sinusoidal or any non-sinusoidal irregular but periodically repeating waveform—with or without background bias level—with an excitation frequency in the range of 1 mHz to 100 kHz.

It is also envisaged that, in still other embodiments of the invention, a different type of light excitation source may be used and/or a different number of light emitting diodes (e.g. one, three or more) may be used.

In use, the LEDs 26,28 are positioned inside the dark enclosure 20 (preferably a light-tight enclosure) to direct their emitted light towards the photosynthetic sample or object (e.g. a leaf) on the sample holder 24. Optical lenses 32 are positioned in front of the LEDs 26,28 to focus the light emitted by the LEDs 26,28 onto the photosynthetic sample (e.g. a leaf). Short-pass filters 34 are positioned between the optical lenses 32 and the sample holder 24 to remove long wavelength emission.

The fluorescence-sensitive detection channel includes an optical fibre 36 and a spectrograph 38. The spectrograph 38 is configured to receive a signal from the optical fibre 26.

In use, the optical fibre 36 and associated input optics are positioned inside the dark enclosure 20 (preferably a light-tight enclosure) to receive the fluorescence emission from the photosynthetic sample or object (e.g. a leaf). An optical lens 40 is positioned between the optical fibre 36 and the sample holder 24 to focus the fluorescence emission onto the optical fibre 36. A long-pass filter 42 is positioned between the optical fibre 36 and the optical lens 40 to filter scattered excitation light.

The electronic circuit 22 includes a processor and memory including computer program code. The memory and computer program code are configured to, with the processor, enable the electronic circuit 22 to carry out various processing functions. In the embodiment shown, the electronic circuit 22 forms part of a dedicated microprocessor that is connected to the spectrograph 38, so that the electronic circuit 22 may be used to record the received fluorescence spectrum as a function of time, and analyse and display the received fluorescence spectrum. The microprocessor is controlled in turn by a desktop or notebook computer used for input/output operations and display. In other embodiments, the electronic circuit may be, may include or may form part of one or more of an electronic device, a portable electronic device, a portable telecommunications device, a mobile phone, a personal digital assistant, a tablet, a phablet, a laptop computer, a server, a cloud computing network, a smartphone, a smartwatch, smart eyewear, and a module for one or more of the same. It will be appreciated that references to a memory or a processor may encompass a plurality of memories or processors.

Use of the spectroscopy apparatus of the invention to measure various fluorescence signals from the leaf is described as follows, with reference to FIGS. 2 to 10.

The below simultaneous time-resolved and wavelength-resolved measurements are described with reference to a dark-adapted sample. In other embodiments of the invention, the below simultaneous time-resolved and wavelength-resolved measurements may apply mutatis mutandis to a light-adapted sample. Measurements on light-adapted samples would be particularly relevant under conditions where dark adaptation would be technically difficult or impossible, e.g. measurements from a distance.

Initially the leaf is left in the dark enclosure 20 for a period of time sufficient to enable the leaf to enter a desired dark-adapted or relaxed state. At the same time zero background signals are recorded by the spectrograph 38 for referencing all signals to zero.

Then, one of the LEDs 26,28 may be controlled to provide a continuous weak actinic light of desirable intensity (which may alternatively be of zero intensity) to initiate the photosynthetic process(es) that may be, but not limited to, FI and NPQ. Either the same or the other LED 26,28 is controlled to provide a repeating pulsed excitation (single pulse or burst pulse) at an excitation frequency of 0.1 kHz to 100 kHz to cause emission of fluorescence from the leaf. Each pulse of the repeating pulsed excitation has a pulse duration in the order of 10 microseconds to several hundreds of microseconds. The optical fibre 36 captures the fluorescence emission from the leaf. In this way, a full fluorescence spectrum is recorded by the spectrograph 38 in very short times (typically for 10 microseconds to several tens of microseconds intervals) upon each pulse of the high intensity LED 26,28. The trigger signal for the pulses of the repeating pulsed excitation may be supplied by the spectrograph 38 so that the pulse generation can be synchronised with the fluorescence detection, or may be supplied by another controller. The measuring time window of the spectrograph 38 is positioned either at the beginning (for Fo′ measurements) or at the end (for Fm′) of an individual excitation pulse, or at any other time delay after the excitation pulse.

In this way the spectroscopy apparatus of the invention is able to obtain simultaneous time-resolved and wavelength-resolved measurements of the fluorescence of the leaf at high resolution (typically at 10 microsecond intervals).

A reference photodiode 45 may be used to monitor scattered high excitation light from the LEDs 26,28 with high time resolution (typically 0.3 to 0.5 microseconds resolution) in order to allow correction of the measured fluorescence signals for small intensity variations of the measuring light pulses across the pulse length and between consecutive pulses.

Optionally, or in parallel in the same apparatus, depending on the desired application, the fluorescence-sensitive detection channel may include a plurality of photodiodes 44 (preferably three or more) equipped with different narrow-band optical filters. Each photodiode 44 may be connected to several respective measurement channels 46 providing sub-microsecond resolution (typically 0.3 to 0.5 microseconds) so that each photodiode 44 is configured to produce a time-signal upon pulse excitation of the fluorescence from a narrow wavelength window of the total fluorescence emission from the leaf.

FIG. 2 shows a schematic graph illustrating the repeating burst pulse excitation mode. An N number of pulses (typically up to several hundred pulses per burst pulse) at high intensity (≥50,000 microEinsteins per second per square metre) are applied by one of the LEDs 26,28 to the photosynthetic object in the repeating burst pulse excitation mode. Each individual pulse has a duration of 10 to 100 microseconds, with the burst pulses being separated by 0.1-10 millisecond intervals. In the particular case where the number of high intensity excitation pulses N per burst equals to 1, the repeating pulse excitation defaults to the single pulse excitation mode. During each individual pulse of the burst pulse, the fluorescence signals recorded by the spectrograph 38 and/or the wavelength-specific photodiodes 44 are measured in a time-resolved and wavelength-resolved manner simultaneously with a time resolution in the range of 0.5 to 10 microseconds. Such burst pulses may be repeated automatically using any interval and any total number of bursts, depending on the purpose of the measurement (including but not limited to FI, NPQ, or other measuring modes). The entire pulse sequence, measuring procedure and data recording may be under the control of a programmable dedicated microprocessor as described with reference to FIG. 1. Weak actinic background irradiation, if desired, can be applied by the LEDs 26,28 or by a separate LED as actinic source under dedicated microprocessor control.

FIG. 3A shows typical 3D time-resolved and wavelength-resolved chlorophyll fluorescence emission spectra from a plant leaf using low intensity (e.g. 600 microEinsteins per second per square metre) actinic background illumination. FIG. 3B shows the normalised time-resolved decay-associated chlorophyll fluorescence emission spectra resulting from a global kinetic analysis. FIG. 3C shows normalised decay-associated spectra of various intermediate fluorescing species induced by the actinic and LED pulsed excitation as resulting from a global kinetic/spectral target model analysis. FIG. 3D shows the corresponding time-dependent concentrations of these intermediately developing and decaying fluorescing species resulting from a global kinetic/spectral target model analysis for the case of a plant that has undergone mild heat treatment (mild heat stress). FIG. 3E shows the same data as FIG. 3D except that the data in FIG. 3E corresponds to a normally grown control plant without any applied stress. Both FI and NPQ information can be derived from these data. It can be seen from FIGS. 3A to 3C that the high resolution of the simultaneous time-resolved and wavelength-resolved measurements of the chlorophyll fluorescence of the leaf by the spectroscopy apparatus of the invention enables spectrally and kinetically resolved separation and identification of components that contribute to the FI, NPQ and other processes initiated by the actinic light in the photosynthetic object. It can be seen from FIGS. 3D and 3E that there are substantial differences in the kinetics of the intermediate fluorescing species from the heat-stressed leaf and control plant and from FIG. 3C that there are significant spectral differences between these species. These differences can be further analysed qualitatively and quantitatively to identify inter alia, but not limited to, the type and level of stress in order to determine the stress condition of the photosynthetic object, the general physiological status, its general health status, or to perform characterisation of the photosynthetic object according to phenotyping and/or genotyping criteria.

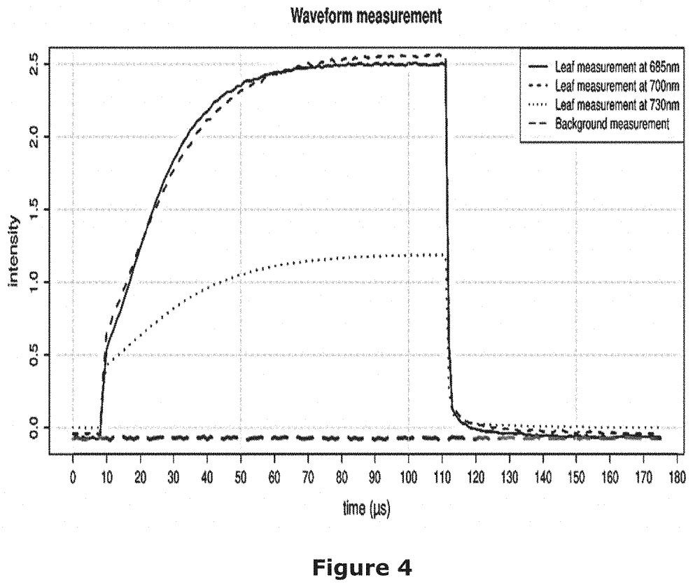

FIG. 4 shows exemplary time-resolved measured fluorescence signals from a plant leaf for three selected wavelength ranges (685 nm, 700 nm and 730 nm, each having a 5 to 10 nm spectral width) for a single high intensity pulse (pulse duration of 100 microseconds) taken from a burst pulse.

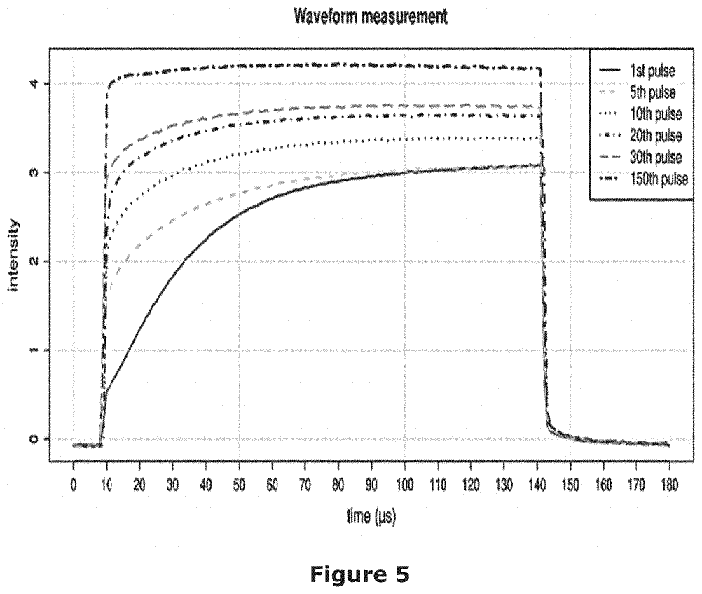

FIG. 5 shows exemplary time-resolved measured fluorescence signals from a plant leaf for one selected wavelength range (685 nm, with a 10 nm spectral width) for a selection of high intensity pulses (pulse duration of 130 microseconds) taken from the same burst pulse. During each pulse, time-resolved and wavelength-resolved fluorescence signals are measured with a 0.5 to 10 microseconds time resolution.

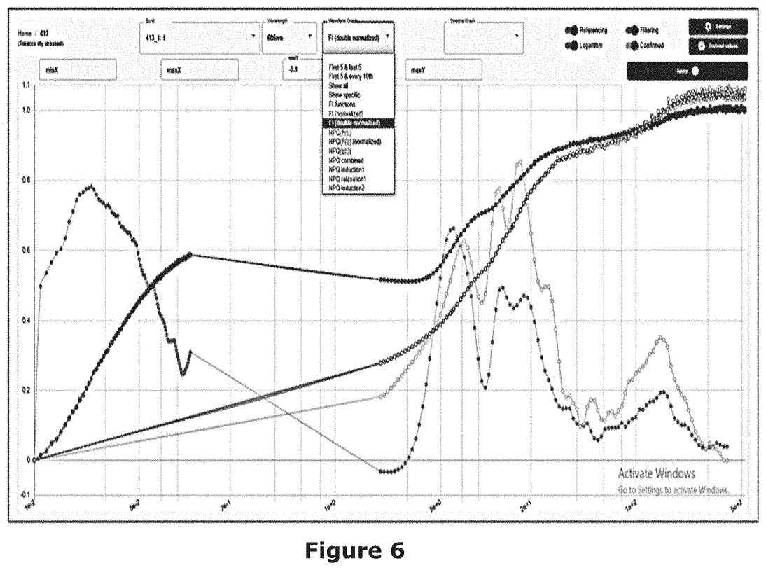

FIG. 6 shows measured FI signals on a semilogarithmic time axis for Fo′ functions (open symbols, representing a fluorescence signal at the beginning of each individual pulse) and Fm′ functions (closed symbols, representing a fluorescence signal at the end of each individual pulse) resulting from a burst pulse. The sample was a mildly dry-stressed tobacco leaf. The signal is double-normalised to the Fm′ signal and is shown for clarity for one particular wavelength range (685 nm, with a 10 nm spectral width) out of the entire recorded spectrum. The same symbol type is used to display the corresponding derivative functions of the FI signals in logarithmic time space. These signals are then classified in a global fashion (three or more/all wavelength ranges combined) by machine-learning algorithms.

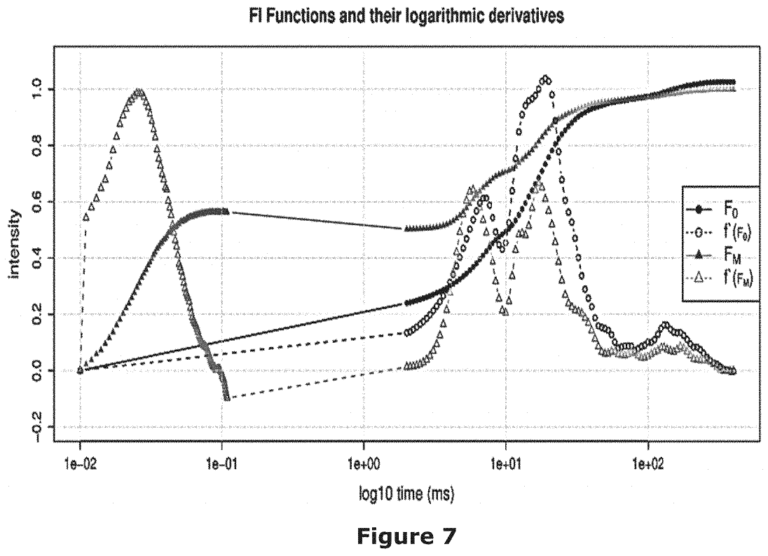

FIG. 7 shows FI signals from a mildly nitrogen-depleted (nutrient-stressed) maize plant. The wavelength range of 685 nm with a 10 nm spectral width is shown on a logarithmic time axis.

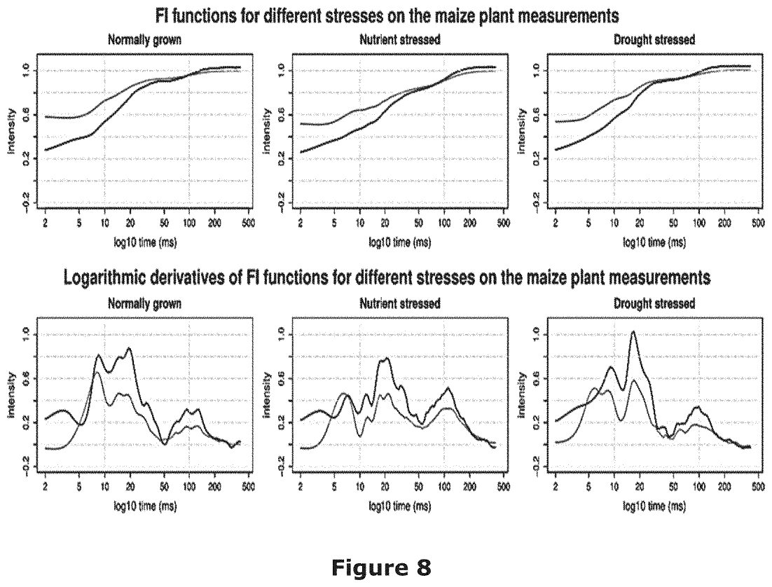

FIG. 8 compares typical effects of different stresses (“nutrient-stressed” meaning mild nitrogen depletion; “drought-stressed” meaning early mild dry-stress on the plant; “normally grown” meaning no stress on the plant) on the FI functions of maize leaves (top row) and their logarithmic derivatives (bottom row). The signals are subsequently subjected to classification by machine-learning (AI) algorithms. The shown fluorescence signals are for the wavelength range of 700 nm with a 10 nm spectral width.

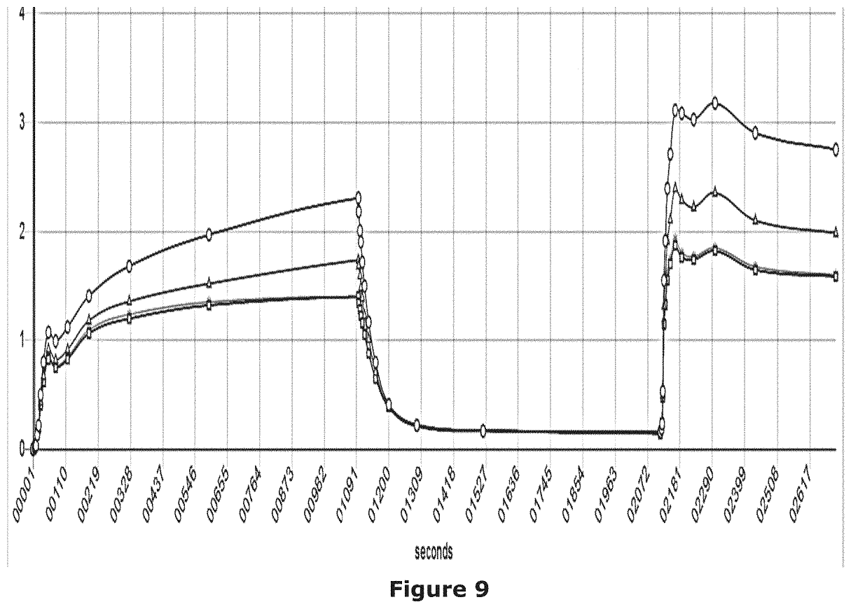

FIG. 9 shows a spectrally and temporally resolved NPQ experiment on a leaf of a normally grown barley plant for four different wavelength ranges (top to bottom: 686 nm, 700 nm, 720 nm and 738 nm, each having a 5 to 10 nm spectral width, selected from the entire spectral range extending from 650 nm to 850 nm). The spectrally dependent effects of an induction phase (600 microEinsteins per second per square metre), a relaxation phase and a second induction phase are shown in FIG. 9.

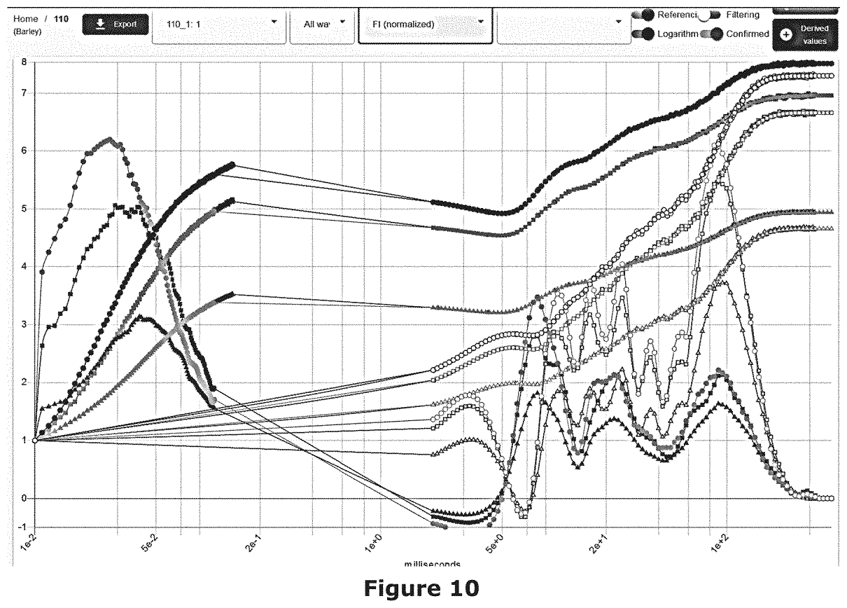

FIG. 10 shows normalised FI measurements on a barley leaf for three selected wavelength ranges (685 nm, 700 nm and 730 nm) for the Fm′ functions (closed symbols) and the Fo′ functions (open symbols) displayed on a semilogarithmic time axis. The same symbol type is used to display the corresponding derivative functions of the FI signals in logarithmic time space.

The inventors have also found that analysing derivatives of the FI (FIGS. 6, 7, 8, and 10) and the NPQ (FIG. 9) on a logarithmic time scale results in significant improvement in providing additional details that enables accurate discrimination of the condition of the leaf. Due to the derivative of a function measuring the sensitivity to a change of the function's output with respect to a change in the function's input, the analysis technique permits accurate tracking of changes in the FI and NPQ that describe the photosynthetic status of the leaf that responds differently to different stresses. Applying such kinds of mathematically derived functions (e.g. derivative functions, logarithmic derivative functions or other mathematical functions based on the originally measured signals) has been found to be particularly useful for the application of machine-learning algorithms (AI) in the classification and differentiation of stress phenomena and their application to phenotyping and genotyping applications.

The recorded FI and NPQ information and their logarithmic time scaled derivatives or other derived mathematical functions of the underlying original functions may be used to create a training set. The training set is then used to train a machine learning algorithm or model over time. A condition of the leaf may be identified and classified based on the output of the machine learning algorithm or model. The inventors have identified a long short-term memory (LSTM) algorithm as being particularly reliable in identifying different types and levels of stress based on chlorophyll fluorescence measurements. Specifically, using the recorded FI and NPQ information and their logarithmic time scaled derivatives in combination with the LSTM machine learning algorithm results in a classification accuracy of around 70% with small amounts of data. Further improvements in classification accuracy (90% and above accuracy) have been found possible using larger training sets. This is in part due to the robustness of the LSTM machine learning algorithm in recognizing patterns in time-series data, such as FI and NPQ data. Such an approach is also useful to characterise photosynthetic objects according to phenotyping and genotyping criteria.

The spectroscopy apparatus of the invention provides at least the following benefits:
i) The spectrally resolved measurement by the invention provides a much broader database for analysis and characterisation of stress phenomena that allows for extraction of more reliable and precise information regarding the health and stress conditions of the plant or photosynthetic object. This is relevant inter alia, but not limited to, the efficient automatic monitoring of ecosystems, such as forests, coral reefs etc., and their responses to climate change and other environmental changes and factors.
ii) The spectrally resolved measurement by the invention provides a much broader database for analysis and characterisation of internal processes triggered by all external factors within the photosynthetic object, not limited to, but in particular light-induced photosynthetic processes, thus enabling a more detailed and more accurate characterisation and separation of photosynthetic reactions, photosynthetic regulation mechanism and responses of photosynthetic objects. This is of high relevance both for fundamental photosynthesis and plant physiology research, as well as for plant breeding aiming at higher crop yields, higher resistance to climate changes, selection of more efficient photosynthetically driven energy producing plants or energy-producing microorganisms for solar conversion to biofuels.
iii) For field applications focused on plant monitoring, growth optimisation and early stress detection, the invention provides a field-ready and user-friendly instrument that is capable of carrying out the requisite fluorescence measurement and analysis.
iv) The incorporation of a machine learning model in the invention to perform automatic analysis and provide expert recommendations makes it easier for non-specialist users to obtain reliable information and take appropriate countermeasures against stress conditions.
v) The machine learning model can be trained by end users to improve and optimise the information about the stress conditions of the plant, thus tailoring the spectroscopy apparatus specifically for certain plants and applications.

It will be appreciated that the above numerical values are merely intended to help illustrate the working of the invention and may vary depending on the requirements of the spectroscopy apparatus and the photosynthetic object.

The listing or discussion of an apparently prior-published document or apparently prior-published information in this specification should not necessarily be taken as an acknowledgement that the document or information is part of the state of the art or is common general knowledge.

Preferences and options for a given aspect, feature or parameter of the invention should, unless the context indicates otherwise, be regarded as having been disclosed in combination with any and all preferences and options for all other aspects, features and parameters of the invention.

1. A spectroscopy apparatus for measuring fluorescence signals from a photosynthetic object, the spectroscopy apparatus comprising:
one or more light excitation sources operable to carry out time-varying excitation of the fluorescence from the photosynthetic object; and
one or more fluorescence-sensitive detection channels configured to simultaneously record the fluorescence as a function of time with a microsecond to millisecond time resolution and as a function of wavelength with a wavelength resolution of 10 nm or better, responsive to the excitation of the fluorescence from the photosynthetic object by the or each light excitation source.

2. A spectroscopy apparatus according to claim 1 wherein the one or more fluorescence-sensitive detection channels includes one or more fluorescence-sensitive detection units or devices.

3. A spectroscopy apparatus according to claim 1 wherein the wavelength resolution of the recorded fluorescence information is achieved continuously across the entire recorded fluorescence spectrum.

4. A spectroscopy apparatus according to claim 1 wherein the wavelength resolution of the recorded fluorescence information is achieved using three or more distinct narrow wavelength bands.

5. A spectroscopy apparatus according to claim 1 wherein the recorded fluorescence information includes fluorescence induction information.

6. A spectroscopy apparatus according to claim 1 wherein the recorded fluorescence information includes non-photochemical quenching information.

7. A spectroscopy apparatus according to claim 1 wherein the time-varying excitation is in the form of a repeating pulsed excitation that has a microsecond to millisecond pulse duration.

8-10. (canceled)

11. A spectroscopy apparatus according to claim 1 wherein the time-varying excitation is in the form of a periodically modulated excitation.

12. (canceled)

13. A spectroscopy apparatus according to claim 1 wherein the time resolution is in the range of 0.5 microseconds to 10 milliseconds.

14. A spectroscopy apparatus according to claim 1 wherein the wavelength resolution is in the range of 1 nm to 10 nm.

15. A spectroscopy apparatus according to claim 1 wherein the electronic circuit includes a processor and memory including computer program code, the memory and computer program code configured to, with the processor, enable the electronic circuit at least to analyse the recorded fluorescence information from the photosynthetic object so as to identify or characterise a condition of the photosynthetic object.

16. A spectroscopy apparatus according to claim 15 wherein the memory and computer program code are configured to, with the processor, enable the electronic circuit at least to analyse modified derivative functions of the recorded fluorescence information from the photosynthetic object so as to identify or characterise a condition of the photosynthetic object.

17. (canceled)

18. A spectroscopy apparatus according to claim 15 wherein the memory and computer program code are configured to, with the processor, enable the electronic circuit at least to analyse the recorded fluorescence information from the photosynthetic object to identify or characterise the condition of the photosynthetic object by providing the recorded fluorescence information as input to a machine learning algorithm or model and identify or characterise the condition of the photosynthetic object based on an output of the machine learning algorithm or model.

19. A spectroscopy apparatus according to claim 18 wherein the machine learning algorithm or model includes a long short-term memory algorithm or a neural network.

20. A spectroscopy apparatus according to claim 15 wherein the condition of the photosynthetic object includes at least one of: a physiological condition of the photosynthetic object; a health condition of the photosynthetic object; and a stress condition of the photosynthetic object.

21. (canceled)

22. A method of measuring fluorescence signals from a photosynthetic object using a spectroscopy apparatus according to claim 1, the method comprising the steps of:
by the or each light excitation source, carrying out time-varying excitation of the fluorescence from the photosynthetic object; and
by the or each fluorescence-sensitive detection channel, simultaneously recording the fluorescence as a function of time with a microsecond to millisecond time resolution and as a function of wavelength with a wavelength resolution of 10 nm or better, responsive to the excitation of the fluorescence from the photosynthetic object by the or each light excitation source.

23. (canceled)

24. (canceled)

25. A computer-implemented method of identifying or characterising a condition of a photosynthetic object, the method comprising the steps of:
recording fluorescence information from the photosynthetic object by carrying out the method according to claim 22; and
analysing the recorded fluorescence information from the photosynthetic object so as to identify or characterise a condition of the photosynthetic object.

26. A computer-implemented method of identifying or characterising a condition of a photosynthetic object, the method comprising the steps of:
collecting a set of data by carrying out the method according to claim 22, wherein the collected set of data includes the recorded fluorescence information from the photosynthetic object;
creating a training set including the collected set of data;
training a machine learning algorithm or model using the training set; and
identifying or characterising the condition of the photosynthetic object based on an output of the machine learning algorithm or model.

27. (canceled)

28. A computer-implemented method according to claim 26 wherein the step of identifying or characterising the condition of the photosynthetic object based on an output of the machine learning algorithm or model includes analysis of stress phenomena associated with a stress condition of the photosynthetic object.

79. A computer-implemented method according to claim 26 wherein the step of identifying or characterising the condition of the photosynthetic object based on an output of the machine learning algorithm or model includes plant, phenotyping or genotyping.

30-34. (canceled)
